(19) United States
(12) Patent Application Publication
(10) Pub. No.: US 2004/0059860 A1
(43) Pub. Date: Mar. 25, 2004

(54) Double-interface adaptor for memory cards

(76) Inventors: Wen-Tsung Liu, Hsin Dian City (TW); Chia-Li Chen, Hsin Dian City (TW); Mi-Chang Chen, (US)

Correspondence Address: TROXELL LAW OFFICE PLLC, SUITE 1404, 5205 LEESBURG PIKE, FALLS CHURCH, VA, 22041, US

(21) Appl. No.: 10/246,632

(22) Filed: Sep. 19, 2002

(51) Int. Cl. G06F 13/20

(52) U.S. Cl. 710/313

(57) ABSTRACT

This invention provides a double-interface adaptor for memory cards, comprising of a double-interface adapter that can access the information stored in a memory card and a USB interface assembly that can be connected to the double-interface adapter. The double-interface adapter has a PCMCIA/CF interface and a USB interface, and it utilizes an interface detection & selection circuit and a controller to switch to the correct system interface selected.

### BACKGROUND OF THE INVENTION

In order to facilitate the portability and access of storage media, manufacturers developed many types of small and light memory cards and corresponding card drives. Currently, the mainstream memory card products in the market include: Multimedia Card (MMC), Smart Media Card (SM), Secure Digital Card (SD), Memory Stick Card (MS), and Compact Flash Card (CF). Because those memory cards have different specifications and sizes, corresponding card drive products or adapters have to be used, resulting in inconvenience and increased cost.

To solve above problem, some manufacturers developed a technology that utilize a single interface or drive to support different memory cards. Such an interface is a standard PCMCIA interface or a Compact Flash Card (CF) adapter, and usually is used in portable information appliances or consumer appliances; while card drives are usually used in PCs/system end. The existing card access approaches (interface or drive) are mainly because PCs don't support PCMCIA or CF interface and PCMCIA/CF interface doesn't support USB interface. In general, when the user wants to access the information stored in a memory card on a PC, a card drive is necessary, which impairs the portability of memory card products. On the other hand, PCMCIA/CF interface is not compatible with USB interface. Therefore it is necessary to integrate above two technologies.

Hence the inventor provides an innovative double-interface adapter for memory cards, which comprises of a double-interface adapter that can access the information stored in a memory card and a USB interface assembly that can be connected to the double-interface adapter. The double-interface adapter has a PCMCIA/CF and a USB interface, and it utilize an interface detection and selection circuit and a controller to automatically switch to the correct system interface selected (i.e., switch a PCMCIA interface to a USB interface, or vice versa).

In addition, the USB interface assembly in the double-interface adapter has no active electronic element, thus its size can be minimized. Compared to legacy card drives, it is more convenient.

Moreover, this invention utilizes a standard PCMCIA interface (or CF adapter) and embedded a USB interface and necessary control circuits in it. Thus it is not necessary to alter the original size and specification. Such a device is more competitive in price in the market.

This invention is further detailed in the following embodiments and illustrations.

### BRIEF DISCRIPTION OF THE DRAWINGS

FIG. 1 is a structure diagram of this invention.

FIG. 2 is a block diagram of the circuit in this invention.

FIG. 3 is a block diagram of the circuit of a PCMCIA/CF adapter in this invention.

FIG. 4 is the flow diagram of this invention.

| | |
|---|---|
| Memory Card | 10 |
| Double-Interface Adapter | 20 |
| Controller | 21 |
| USB Bus Interface Circuit | 211 |
| PCMCIA/CF Bus Interface Circuit | 212 |
| Data Cache | 213 |
| Microprocessor | 214 |
| Memory Card Connector | 22 |
| Interface Detection and Selection Circuit | 23 |
| Power Transformation & Protection Circuit | 24 |
| PCMCIA/CF Interface | 25 |
| USB Interface Assembly | 30 |
| PCMCIA/CF Connector | 31 |
| USB Interface | 32 |

### DETAILED DESCRIPTION OF THE DRAWINGS

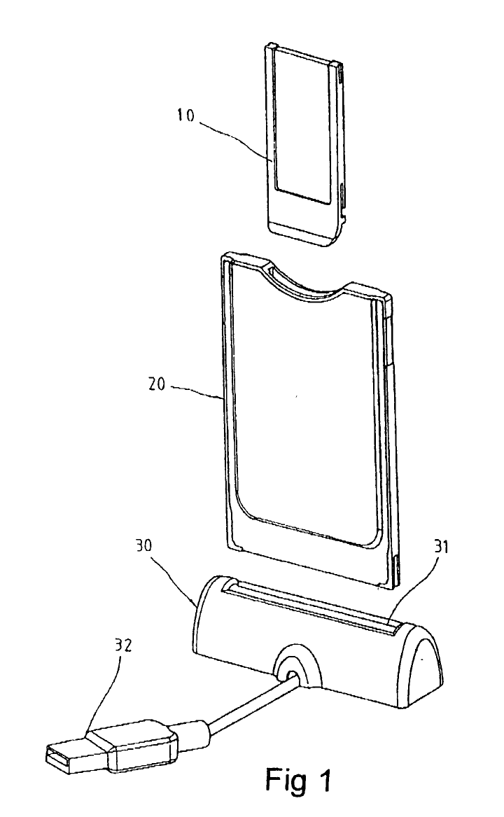

Please see the embodiment of this invention in FIG. 1, the double-interface device comprises of:

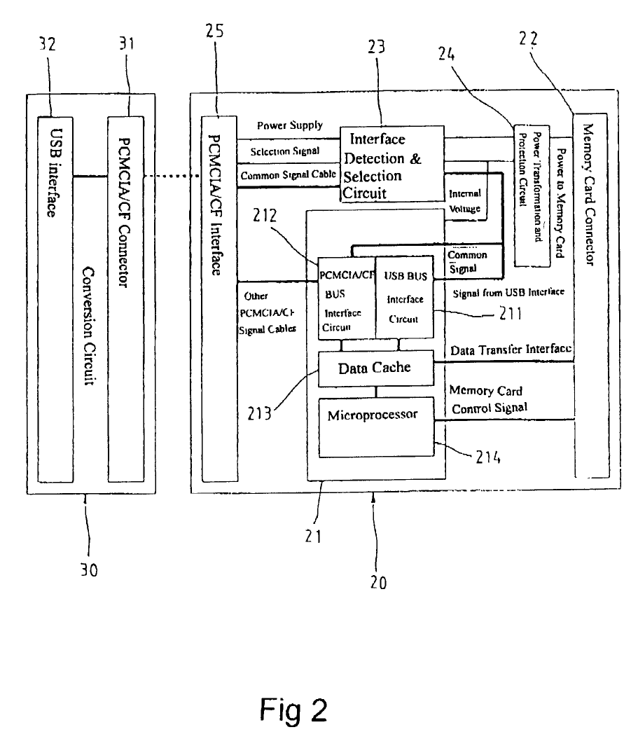

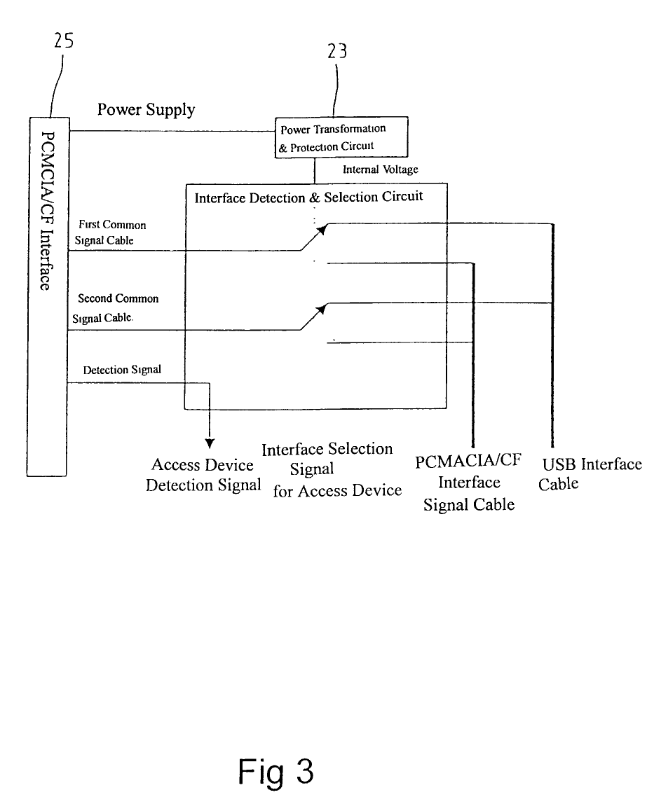

a double-interface adapter 20 that can access the information stored in a memory card 10 and a USB interface assembly 30 that can be connected to the double-interface adapter 20. The double-interface adapter 20 delivers both a PCMCIA/CF interface and a USB interface (in FIG. 1, a PCMCIA/CF interface is shown). Please see FIG. 2 and FIG. 3, the double-interface adapter 20 comprises of:

a controller 21 with a standard USB Bus interface circuit 211 and a standard PCMCIA/CF Bus interface 212 embedded, a cache 213 for data transfer to cache data in the data transfer process between the memory card and the standard USB interface, a microprocessor 214 with a ROM, a cache, and an access control interface embedded to perform detection, switching, and control, a connector 22 to host a memory card 10, through which the data are transferred to the memory card 10 under the control of the microprocessor 214, and an interface detection and selection circuit 23 to deliver detection and switching functions, a power transformation and protection circuit 24 to convert the voltage applied on the USB Bus interface or PCMCIA/CF Bus interface into the internal voltage on the double-interface adapter 20 with over current and surge protection functions, a PCMCIA/CF interface 25 to support a PCMCIA/Compact Flash storage device.

The USB interface assembly 30 comprises:

a USB interface;

a PCMCIA/CF connector 31 to connect to the double-interface adapter 20 to switch to the said standard PCMCIA/CF interface (at the same time, the controller 21 in the double-interface adapter 20 supports and control the circuit for the standard USB interface to determine whether to select the USB interface to perform data transfer);

a convert circuit to connect the circuit for the USB interface to the predefined position on the PCMCIA/CF connector.

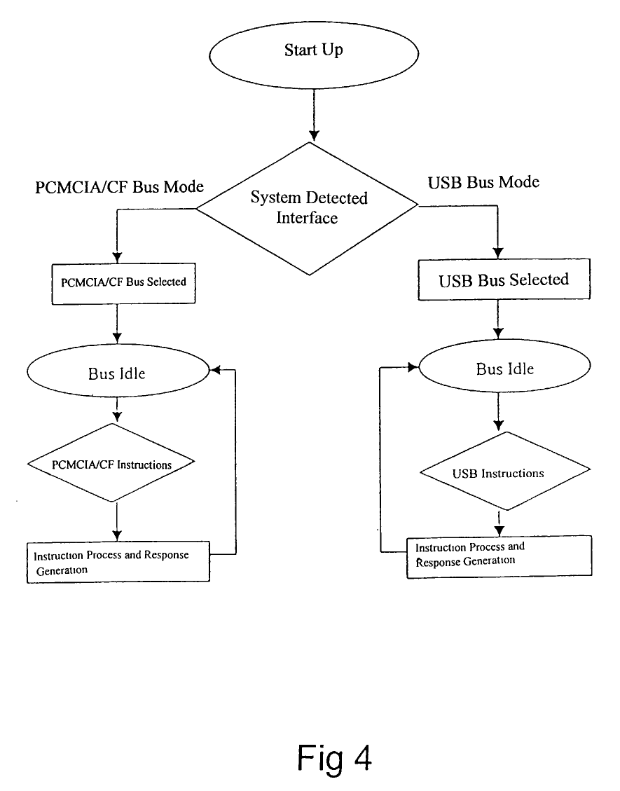

From above description we can see that the double-interface device supports both system interfaces. A program for processing above two system interfaces is hosted in the internal controller 21 of the double-interface adapter 20 to support instructions and communication protocols generated from different interfaces. As shown in FIG. 4, after the system is launched and the double-interface adapter 20 is powered, the double-interface adapter 20 will switch to the correct working mode and activate an appropriate system interface according to the system detected by the interface detection and selection circuit 23. After the system interface is activated, the microprocessor 214 will accept the instructions from the system end and process them according to the specification for the system interface and generate appropriate response.

The above embodiment shall not constitute any limitation to the invention. It is stated that any implementation result from any equivalent replacement or modification to the invention should fall into the category of this invention.

What is claimed is:

1. A double-interface adapter structure comprising of a double-interface adapter that can access the information stored in a memory card and a USB interface assembly that can be connected to the double-interface adapter; the double-interface adapter has a PCMCIA/CF interface and a USB interface, and it utilizes an interface detection & selection circuit and a controller to switch to the correct system interface selected.

2. The double-interface adapter structure as in claim 1, wherein the controller has a data transfer cache embedded to cache data in the process of data transfer between the memory card and the USB interface.

3. The double-interface adapter structure as in claim 1, wherein the double-interface adapter has a power transformation & protection circuit embedded to convert the voltage applied on the USB Bus interface or PCMCIA/CF Bus interface into the internal voltage on the double-interface adapter with over current and surge protection functions.

4. The double-interface adapter structure as in claim 1, 2, or 3, wherein the controller has a microprocessor embedded, and the microprocessor has a ROM, a cache, and a access control interface to perform detection, switching, and control actions.

5. The double-interface adapter structure as in claim 1, wherein the USB interface assembly comprises of:
a USB interface;
a PCMCIA/CF connector to connect to the double-interface adapter to switch to the said standard PCMCIA/CF interface;
and a convert circuit to connect the circuit for the USB interface to the predefined position on the PCMCIA/CF connector.

6. The double-interface adapter structure as in claim 1, wherein the size and specification of the double-interface adapter can be shared by a standard PCMCIA interface adapter or a CF interface adapter.
